(19) United States
(12) Patent Application Publication
(10) Pub. No.: US 2015/0310750 A1
(43) Pub. Date: Oct. 29, 2015

(54) METHOD FOR VERIFYING THE VALIDITY OF REACTIONS OF A PERSON

(71) Applicant: Klaus GLAUNSINGER, Tübingen (DE)

(72) Inventor: Klaus Glaunsinger, Tuebingen (DE)

(21) Appl. No.: 14/649,359

(22) PCT Filed: Nov. 26, 2013
(86) PCT No.: PCT/EP2013/074722

§ 371 Date: Jun. 3, 2015

(30) Foreign Application Priority Data
Dec. 3, 2012 (DE) 10 2012 111 733.0

(51) Int. Cl. G09B 5/02

(52) U.S. Cl. CPC G09B 5/02

(57) ABSTRACT

Method for checking the validity of reactions of test subjects, wherein a stimulus is demonstrated to the test subject, wherein evoked potentials are derived from the brain wave curves or the brain areas are depicted by functional imaging methods, and a reaction time task is assigned to the test subject and the reaction is measured, wherein the readiness potentials and/or the event-related potentials (ERPs) and/or the components of the ERPs and/or the event-related desynchronization (ERD) of the brain wave curve is derived and/or the brain areas are depicted by functional imaging methods.

The invention relates to a method for verifying the validity of reactions of a person.

Psychological test investigations of test subjects are, in many cases, an expert evaluation in a compensation-relevant context (accident insurance, occupational disability and disability for service etc.). For this, knowledge regarding willingness for exertion and the validity of the asserted complaint—so how willing the test subject is to provide information in full and truthfully, with full mental capacity and without pretending to submit false facts, or to undergo predetermined tests—is of great significance for an objective evaluation.

Verifying the validity of a complaint is indispensable for diagnosing a mental health disorder. One important criterion for this is measuring the willingness for exertion of the test subject.

The frequency of deception attempts is well documented in this case and is, in the German-speaking world, up to 50%, whereas the proportion of deception attempts is somewhat higher still in the USA. The damage for the social community caused by undetected deception is, as a consequence, immense.

Prior art for the overwhelming majority of test methods for registering the complaints of a test subject are paper-dependent self-assessment questionnaires which are manually filled in by the test subject and are evaluated by using answer sheets. Numerous testing methods, both on paper and occasionally on PC, are available for testing cognitive functions.

Nowadays, verifying the willingness for exertion and complaint validity of the test subject can be undertaken by several separate test methods as well as the test that is actually carried out. Therefore, on the one hand, manifestly valid test methods are used which provide the verification of cognitive functions, but in reality contain very simple problems that are to be solved by, for example, brain-damaged test subjects and test subjects suffering from dementia. The evaluation of their results then enables a conclusion to be drawn about the willingness for exertion of the test subject being examined. On the other hand, the common methods are used to verify consistency of answers, which enables conclusions to be drawn about test performance. Verifying the validity of a complaint can, in addition, take place by means of questionnaires. Here, as well as actual symptoms, absurd symptoms are inquired about and, with the aid of sum scores, a conclusion is drawn as to what extent the complaints appear to be authentic.

The general recommendations of specialist associations are that more and more methods should be used. The conclusive evaluation of the test performance is incumbent upon the expert/assessor.

The hitherto established methods only cover a very small part of the possibilities for testing and validation in which complaint clarification can be conducted. It is fundamentally easy to simulate deficiencies in all functional areas of the body. Methods for exposing simulation or aggravation in physical (e.g. neurological) examinations (such as sensory disorders) or in attention tests (direct objective validation of reaction times) exist to date neither in scientific nor patent-related literature.

A method for verifying the validity of reactions of a person is known from U.S. Pat. No. 5,957,859, wherein the test subject is exposed to a test stimulus and, in parallel to the measurement of the reaction to this test stimulus, the event-related potential (ERP) is also measured by deriving the electroencephalogram of the test subject. The values are compared to the values that the test subject showed when in the presence of a control stimulus that is to correspond to an actual reaction. The disadvantage of this method is that the test subject is able to distort the evaluation by manipulating the reaction to the control stimulus and there is no objectifiable and reproducible technical possibility for verifying the truth content of the reaction of the test subject to the control stimulus.

The object of the invention is to provide a method enabling manipulation during the verification of the validity of reactions by untruthful control stimulus reactions to be prevented and enabling the verification of the validity of reactions of a test subject to be carried out reproducibly.

This object is solved by the features of claim 1.

In the method according to the invention, the verification of the validity of the reaction of the test subject takes place by a stimulus being demonstrated to the test subject by deriving the evoked potentials (EP) from the brain wave curve or by representing the brain sections by means of functional imaging methods and by the test subject undergoing a reaction time test and the reaction time being measured by deriving the readiness potential and/or the ERP (event-related potential) and/or components of the ERP such as ERN (error-related negativity) and/or ERD (event-related desynchronisation) of the brain wave curve and/or the representation of the brain sections by means of functional imaging methods.

In the method according to the invention, by deriving the evoked potentials from the brain wave curve or representing the activity of the brain sections by means of functional imaging methods (e.g. NIRS (near-infrared spectroscopy) or fMRT (functional magnetic resonance imaging)), it can be verified during the demonstration of the stimulus as to whether the stimulus has penetrated the consciousness of the test subject. Both an electrophysiological and imaging method are therefore provided, which are reproducible.

Deriving evoked potentials is a reproducible, electrophysiological method. Visually evoked potentials (VEP), BAEP (brainstem auditory evoked potentials), somatosensory evoked potentials (SEP) or olfactory evoked potentials are preferably derived.

At the same time, the test subject is subjected to a reaction time test, preferably in such a way that the test subject is to react immediately to a stimulus and the reaction time is measured by deriving the readiness potentials and/or the ERP and/or the ERD of the brain wave curve and/or the representation of the brain sections by means of functional imaging methods.

Within the scope of the present invention, readiness potentials are, in particular, understood to be the motor and/or lateralised readiness potentials (RP and/or LRP). In this instance, the LRPs are determined to be both stimulus-locked (sLRP) and response-locked (LRPr). This provides the advantage that processes involved before the selective activation (i.e. processes in the interval between the presentation of the stimulus and the occurrence of the LRP) may be differentiated from subsequent processes (i.e. processes in the interval between the occurrence of the LRP and the initiation of the observed response) (Eimer, 1998; Mordkoff, Miller & Roch, 1996). The present invention thereby eliminates the deficiency in the prior art, when only stimulus-locked ERPs were used to date for evaluation and the readiness potentials that were able to be derived from a reaction remained unconsidered. Therefore, sensitivity and specificity are increased by the present invention.

A correlation occurs in such a way that the absolute values of the reaction times and the variances thereof are set relative to the readiness potentials and/or the ERP and/or the ERD. In a second step of the evaluation, the readiness potentials and/or the ERP (amplitudes and latencies) and/or the ERD and/or activation values of the functional imaging methods are compared with the values known from other investigations.

According to the invention, differentiation between a deliberate delay and a genuine delay due to a cognitive disorder can be made unambiguously. The willingness for exertion of test subjects can hereby be determined and evaluated.

According to the invention, lateralised readiness potentials are preferably derived, since the distortions arising during the evaluation of the ERP can be prevented by other potentials (potential side errors).

In the method according to the invention, after it has firstly been verified by evaluating the brain waves or the imaging methods as to whether the stimulus has penetrated consciousness and whether the method according to the invention additionally takes into account, during the assessment and evaluation, how the LRP performance of healthy test subjects who react with full performance willingness or intentionally distort their answers and how test subjects with genuine cognitive disorders, e.g. dementia patients or those with mental illnesses, the truthful reaction required in the prior art for a correct evaluation can be omitted from the control stimulus. This takes place by, as well as the electrophysiological derivation of the cited evoked potentials and/or activity levels of the corresponding brain sections acquired by imaging, a comparison with specialist data about the cited readiness potentials and/or the ERP and/or the ERD raised in extensive clinical studies of healthy test subjects reacting with full performance willingness, healthy test subjects who are distorting their answers and test subjects with cognitive disorders, being carried out.

The problems in the prior art arising as a result of the prerequisite for the stimuli being known and due to manipulation in the control stimuli are thus prevented.

In a preferred embodiment, in addition to the simultaneous derivation of the LRP, ERP (with ERN) or ERD and the evoked potentials, as well as, in addition or by way of replacement, application of functional imaging methods, the activity of the target muscles is also derived and this is included in the evaluation. This takes place in such a way that muscle activity (EMG, electromyogram) is preferably measured by a surface derivation from the muscles required for the reaction.

Detection of potential pre-innervation of the target muscles is hereby achieved before the visible, and preferably motor, reaction. By way of comparison with the determined reaction times and the aforementioned potentials resulting from the brain wave curve and/or the results of the functional imaging methods, it can be ascertained as to whether a motor reaction was already knowingly initiated, the effect of which, however, was still retained on purpose.

In addition, the method can therefore serve facultatively for the measurement of the muscle activity of the muscles required for the reaction, whereby a functionally ineffective pre-innervation (non-visible reaction) can—in contrast to the prior art—be detected.

A further advantage of the present invention consists in that this also takes brain wave responses of actual patients into consideration. This is not the case in the hitherto existing methods, since the cause of false responses which, for example, could also be a brain injury in the dorsolateral prefrontal cortex (“lying centre”), has so far not been considered.

The derivation preferably takes place at at least eight locations in accordance with the internationally recognised 10-20 system. The problems arising with central derivation points, such as physiological side differentiation (e.g. problems with the dominant hemisphere: the speech centres are on the left-hand side in right-handed people and vice versa, in the course of lateralisation arising from readiness potentials), are prevented by multilocular derivation. Moreover, from field recording by multilocular derivation of the cited brain wave potentials, a higher level of validity of the cited potentials results from physiological or pathological brain wave curve changes being detected and taken into consideration in the evaluation of the potentials, and thus the artefact susceptibility existing in the prior art being remedied.

Due to the fact that, in the method according to the invention, the entire response behaviour, and hence defective or insufficient responses, is included in the evaluation, the method is far more reliable than the hitherto known methods, since it takes into consideration the fact that insufficient or defective responses may also arise as a result of physiological and/or mental disorders.

In order to keep the influence of factors that may potentially have a negative effect on the evaluation as low as possible, a very simple reaction test is administered according to the invention, such that few cognitive processes can enter this, as was the case in previously known methods.

The method according to the invention also enables the test methods known to date to be supplemented.

The method according to the invention provides the verification of reaction times achieved by test subjects by using an EEG (electroencephalogram) by determining the cited readiness potentials and/or the ERP and/or the ERD and/or by imaging the brain sections by means of functional imaging methods, with respect to their validity, and provides the automated evaluation of this data.

The method according to the invention also enables the verification of the validity of reaction times on the basis of a physically verifiable measurement of the brain waves of a test subject, and indeed without—as before—a consistency validation always having to be used alternatively to assess validity. The previously required consistency validation caused a considerably poorer level of sensitivity and specificity than in the method according to the invention.

In this instance, the method serves for the measurement of brain waves with the EEG and/or the imaging of brain sections by means of functional imaging methods. A recurring, for example visual, audible, electrical, tactile or olfactory stimulus is shown to the test subject undergoing investigation. This contains the test of reacting as fast as possible to the stimulus and pressing a button. Here, the VEP and/or AEHP and/or SEP and/or olfactory evoked potentials established in the routine diagnostics are also derived in order to show that the test subject was able to detect the stimulus.

Within the scope of the method according to the invention, an automatic, computer-based evaluation of the extensive measurement data preferably takes place with a mathematical algorithm. The evaluation and integration of all functions and devices takes place on a computer, with which an EEG device and a device for the presentation of the stimulus are connected.

Finally, an assessment recommendation with respect to the validity of reactions is pronounced by compiling a result assessment recommendation for the expert/assessor on the basis of the automatic evaluation, said recommendation enabling a clear distinction between consciously delayed motor actions and reaction delays that are actually based on brain dysfunctions. Here, the result assessment recommendation can be emitted, for example, either as a paper copy or as a digital notification.

Within the scope of the present invention, brain wave curves of the cerebral cortex are preferably measured, since deeper lying brain regions are not able to be measured clearly without using invasive techniques. The brain waves are preferably measured by means of EEG.

A device according to the invention is configured in such a way that a playback device, a reaction device and a reaction timer are used. A computer is also included, on which a mathematical algorithm runs and, here, the results of the playback device, the reaction device and the reaction timer are put in direct relation with the evaluation of the brain wave curves and/or the imaging of the brain sections by means of functional imaging methods and the EMG. An audio and/or visual and/or tactile and/or olfactory device can, for example, be included as the stimulus device. A reaction device can, for example, be a push button or a joystick. The reaction timer is configured in such a way that it measures the time between the playback of the audio and/or visual and/or tactile and/or olfactory device and the actuation of the reaction device.

The method according to the invention is described in greater detail below in one potential embodiment using the example of a visual stimulus and the derivation of the LRP:

It is explained to the test subject that he/she is to react as fast as possible to a visual stimulus (“reaction time test”).

In this example, the stimulation takes place by way of a checkerboard pattern that randomly inverts in terms of its temporal sequence. The stimulus is applied in a 200× measuring process. The reaction time test runs in such a way that the test subject is to react as soon as he has perceived the stimulus in the form of an inversion of the checkerboard pattern. In this example, the reaction takes place by way of a push button.

The test subject is connected to an EEG and the stimulus is demonstrated by deriving the evoked potentials from the brain wave curves and measuring the reaction time. The evoked potentials—in the present example VEPs—are determined by means of stimulus-triggered averaging from the brain wave curve derived from the corresponding brain sections (bi-occipital in the present example). The readiness potentials are thus determined analogously to the determination of the VEP—though still multilocularly—and, in addition, in a reaction-triggered manner. Thus, with reaction-triggered averaging, a period of at least 500 ms before the reaction and 1200 ms after a completed reaction is examined. With stimulus-triggered potential averaging, a period of at least 800 ms after the stimulus is recorded.

The verification of the validity now takes place on the basis of these measured values:

By deriving and measuring the visually evoked potentials in the present example in accordance with latency and amplitude, it is verified by comparing the determined values with standard value tables that are generally recognised in the field of neurology as to whether the stimulus has penetrated the consciousness of the test subject, so whether the test subject was able to perceive the stimulus.

In addition, the LRPs—determined from the brain wave curves by reaction and stimulus-triggered averaging (LRPr and sLRP)—are measured according to latency and amplitude. There then takes place a comparison with the known, in particular statistically valid data, from the clinical investigations on healthy test subjects who are reacting with a conscious delay and with full readiness potential and on test subjects who are brain-damaged and present with a mental disorder, in the present example those with a depression-related illness. This succeeds due to the performance of the cited readiness potentials which, in particular, significantly differ in terms of their amplitudes between the conditions of full willingness for exertion and an intentionally negative response distortion—even for the test subjects who are known to be ill.

One final thing was able to be confirmed in an examination of 60 healthy test subjects and 60 test subjects with a depression-related illness, who, as well as the reaction time test described above, were requested, in a further part of the test, to react 0.5 seconds after a stimulus by pressing a button (in accordance with a conscious reaction delay): for several derivation points between both conditions, there were significant differences between the LRP and ERP amplitudes.

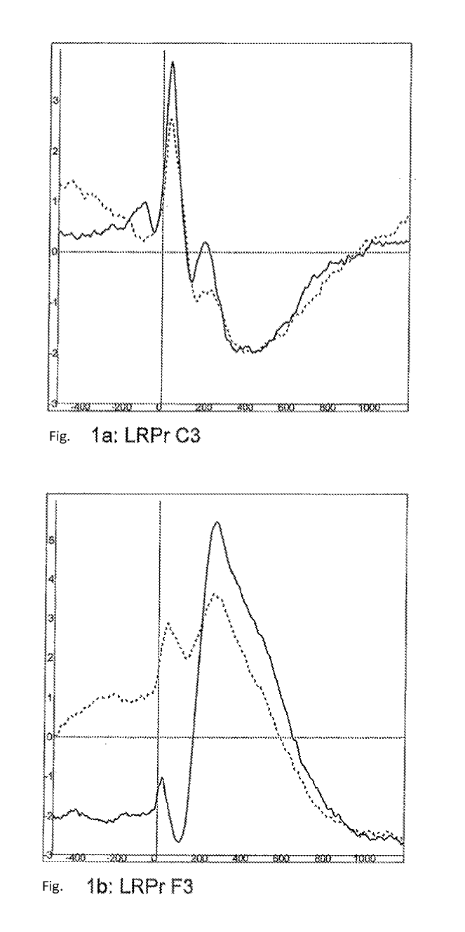

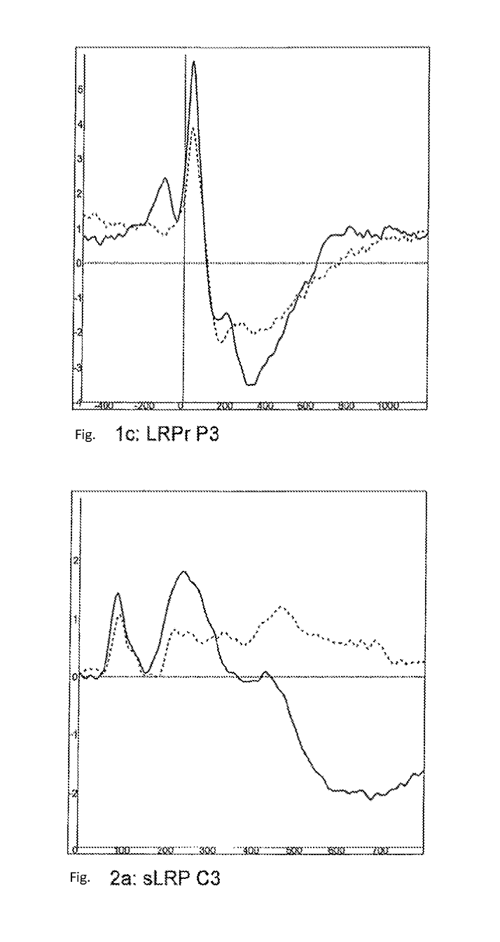

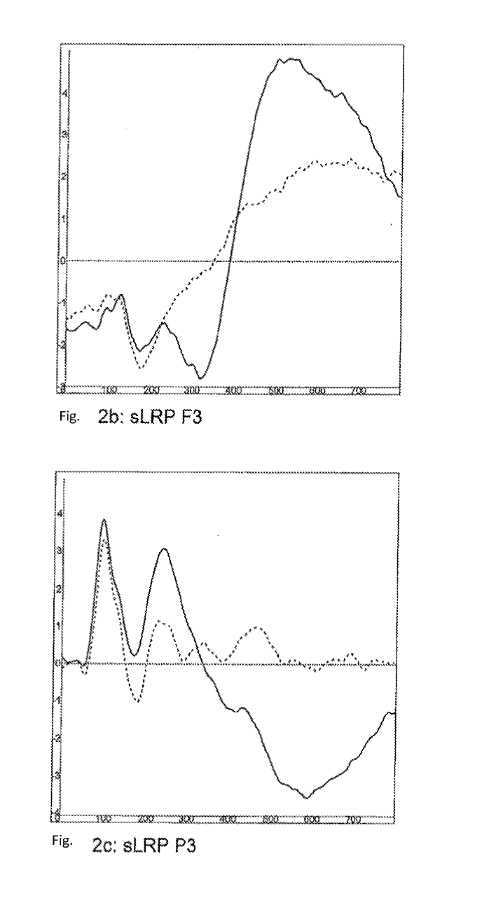

FIGS. 1a-c show, by way of example, the reaction-triggered LRPs of different derivation points in healthy test subjects, while FIGS. 2a-c show the stimulus-triggered LRPs of different derivation points in healthy test subjects. The curves drawn result from the exertion condition, and the dotted curves result from the condition of a conscious reaction delay. The significance level is, for all results depicted in the figures, p<0.001. For all of the figures, the amplitudes are shown in μV on the y axes, and the time is shown in ms on the x axes.

In addition, for the result evaluation in the present example, the potential configuration (temporal progression of the positives and negatives), which can be different depending on the illness, is taken into consideration in the evaluation. Moreover, absolute values and variances in the reaction times are compared with those of healthy test subjects who respond with full willingness for exertion.

The evaluation recommendation thus results from a verification of the validity of the reaction times and the distribution thereof, and from a comparison of the potentials and their amplitudes with results from the cited studies.

1. Method for verifying the validity of reactions of test subjects, characterised in that a stimulus is demonstrated to the test subject by deriving evoked potentials from the brain wave curves or by representing the brain sections by functional imaging methods, and the test subject is subjected to a reaction time test and the reaction time is measured by deriving the readiness potentials and/or the event-related potentials (ERP) and/or the components of the ERP and/or the event-related desynchronisation (ERD) of the brain wave curve and/or the representation of the brain sections by functional imaging methods, wherein the evaluation takes place in such a way that the absolute values of the reaction times and the variances thereof are set relative to the readiness potentials and/or the ERP and/or the ERD and/or representation of the brain sections by functional imaging methods and the readiness potentials and/or ERP and/or ERD and/or representation of the functional imaging methods are compared to the values known from other investigations.

2. Method according to claim 1, characterised in that the evoked potentials are visually evoked potentials (VEP), brainstem auditory evoked potentials (BAEP), somatosensory evoked potentials (SEP), taking into account tactilely evoked potentials, or olfactory evoked potentials.

3. Method according to claim 1, characterised in that the imaging methods are functional magnetic resonance imaging (fMRT) or near-infrared spectroscopy (NIRS).

4. Method according to claim 1, characterised in that, in addition to the simultaneous derivation of the readiness potentials and/or ERP and/or ERN and/or ERD and/or the representation of the brain sections by functional imaging methods and the evoked potentials, the activity of the target muscles is also derived.

5. (canceled)

6. Method according to claim 1, characterised in that the absolute values of the reaction times and the variances thereof are also set relative to the activity of the target muscles.

7. (canceled)

8. Method according to claim 1, characterised in that the comparison with the known data from the clinical and/or statistically valid investigations takes place on healthy test subjects who are reacting with a conscious delay and with full readiness potential and on test subjects who are brain-damaged and present with a mental disorder.

9. Method according to claim 1, characterised in that the derivation takes place at at least eight locations.

10. Use of the method according to claim 1 for assessing the willingness for exertion and complaint validity of test subjects in psychological test investigations in a compensation-relevant context.

11. Method according to claim 1, characterised in that, by evaluating the brain waves or the imaging methods, it is firstly verified as to whether the stimulus has penetrated consciousness.

12. Method according to claim 1, characterised in that the evaluation recommendation is carried out from a verification of the validity of the reaction times and the distribution thereof, and from a comparison of the potentials and their amplitudes with the values known from other investigations.
